(19) United States
(12) Patent Application Publication
(10) Pub. No.: US 2006/0252949 A1
(43) Pub. Date: Nov. 9, 2006

(54) Recovery of residual specialty oil

(76) Inventors: Lalit Chordia, Pittsburgh, PA (US); Jose Luis Martinez, Gibsonia, PA (US)

Correspondence Address: MEYER UNKOVIC & SCOTT LLP, 1300 OLIVER BUILDING, PITTSBURGH, PA, 15222, US

(21) Appl. No.: 11/483,995

(22) Filed: Jul. 10, 2006

Related U.S. Application Data
(63) Continuation-in-part of application No. 10/949,631, filed on Sep. 24, 2004, now Pat. No. 7,091,366.
(60) Provisional application No. 60/505,904, filed on Sep. 25, 2003.

(51) Int. Cl. C11B 1/00

(52) U.S. Cl. 554/8

(57) ABSTRACT

The present invention provides a means for the recovery of any residual specialty oil from a cake using a compressed solvent, preferably carbon dioxide. The present invention also allows for the cake to be pretreated before extraction. The compressed solvent can be recycled and the process is continuous.

### CROSS-REFERENCE TO RELATED APPLICATION

This application is a continuation-in-part application of U.S. non-provisional patent application Ser. No. 10/949,631 filed on Sep. 24, 2004, which itself claims priority to U.S. provisional patent application Ser. No. 60/505,904 filed on Sep. 25, 2003.

### FIELD OF THE INVENTION

The invention generally relates to a process for recovering oil from a cake and more particularly relates to recovery any type of specialty oil from a cake.

### BACKGROUND OF THE INVENTION

Specialty oils are valuable commodities for a number of reasons, including but not limited to, their nutritional, cosmetic, and therapeutic uses. The term “specialty oil” typically refers to oil that occurs in low volume, as compared to commodity oils, has unique functionality or improved health benefits. Many of these specialty oils have anti-bacterial properties and, therefore, can be used to treat infections. Skin care preparations have used oils in formulations for centuries. Additionally, specialty oils have significant health benefits. For example, a number of them can treat a number of serious medical conditions such as diabetes, high blood pressure and cholesterol, migraine headaches, and even certain types of cancer. Many specialty oils are able to preserve cell membrane function due to their high content of essential fatty acids and are also rich in antioxidants.

There are a number of oils that fit into the category of specialty oils, many of which are quite expensive. Some oils representatively used in the present invention include, but are not limited to, the following: borage, evening primrose, flaxseed, hemp, black currant, walnut, jojoba, rosehip seed, sesame seed, almond, avocado, black cumin, grapeseed, kukui nut, macadamia nut, olive, pecan nut, perilla, poppyseed, pumpkin, sea buckthorn, shea nut, tamanu and watermelon. Because of the lipophilic nature of specialty oils and the physico-chemical characteristics of compressed solvents, it will be apparent to those skilled in the art that other oils may be used with this invention. These specialty oils are a natural source of essential fatty acids that cannot be synthesized by the body (animal or human). Therefore, they must be obtained through a proper diet. A deficiency of essential fatty acids has been identified in mental disorders, diabetes, atherosclerosis, hypertension, immune dysfunction, and inflammatory conditions. Each of these specialty oils has specific applications and benefits. For example, borage oil, one of the most expensive oils, helps to repair sun damaged and aging skin, as well as maintain healthy skin. Hemp oil can be absorbed directly into the skin. Jojoba oil is often used in hair care products and applications. Sea buckthorn oil is traditionally used in the treatment of gastric ulcers. It also provides anti-tumor effects and protects the liver from damaging effects of toxic chemicals. Perilla oil has anti-inflammatory and antiseptic properties. Black cumin seed improves digestion and helps to lower blood sugar levels. Pecan nut oil has been shown to reduce the risk of coronary heart disease.

Another specialty oil of great value is sesame oil. Sesame is cultivated in India, China, Sudan, Korea, and Mexico. The oil, which is rich in antioxidants and pain relieving compounds and high in polyunsaturated fat, has natural antibacterial, antiviral, and anti-inflammatory properties. In fact, it has been used in the treatment of conditions such as diabetes, hepatitis, and migraine headaches. Studies have also shown that sesame oil has inhibited the growth of malignant melanoma and the replication of human colon cancer cells due to the fact that it is a cell growth regulator and, therefore, can slow down replication and cell growth. Other research has shown a variety of benefits from the use of sesame oil such as reduction of the bacteria that causes gingivitis, cure of chronic sinusitis, protection from UV rays, and maintenance of beautiful skin. Therefore, because of its human health benefits, as well as the fact that it is a low volume product, sesame oil is considered to be a specialty oil.

Sesame seeds are comprised of approximately 50% to 60% fatty oil containing compounds such as sesamin, sesamolin, and sesaminol. Sesaminol is present in the seeds mainly as glycoside, and it can be produced from sesamolin. More than 75% of sesame oil consists of unsaturated fatty acids, with almost equal portions of oleic and linoleic acid.

In most Asian countries, hot-pressed sesame oil is preferred. The sesame seeds are toasted before pressing. Toasting the seeds increases their flavor, which is a result of the compounds 2-furylmethanthiol, 2-methoxyphenol (guajacol), phenylethanthiol, and 4-hydroxy-2,5-dimethyl-3(2H)furanone (furaneol). Also adding to the flavor are vinylguacol, 2-pentylpyridine, and other N-containing heterocycles.

Specialty oils are obtained from seeds either by mechanical pressing or by extraction. Extraction tends to be a chemical treatment via an organic solvent, such as hexane or a supercritical fluid, such as carbon dioxide.

In the case of specialty oils, mechanical pressing is often the preferable route. This is because there is no residual organic solvent left in the cake, and there is no evaporation step required in either the oil or in the cake. Therefore, these products are very attractive to the organic market. However, mechanical pressing leaves residual oil in the cake. The amount of residual oil depends mainly of the type of expeller and the temperatures used. Additionally, the cake is wasted or used in applications such as feed for livestock for a very low price. The fact remains that each time this process is performed, a significant portion of the specialty oil is not recovered. Because specialty oils are such valuable commodities, the recovery of the oil in the cake would have great economic implications.

An expeller press uses friction and continuous pressure from a screw drive to move and compress the seed material. The oil seeds pass through small openings that do not allow seed fibrous solids to pass through. Afterward, the pressed seeds are formed in the press into a hardened cake, which is generally regarded as waste. The residual oil content in the cake ranges anywhere from 5 to 15 weight percent (wt. %). However, in some cases, such as sesame seeds, the residual oil content can be as high as 20%. At present, the issue of recovering the residual oil from these cakes has not been readily addressed. This invention provides a novel process for recovering the residual specialty oil left in the cake.

### BRIEF SUMMARY OF THE INVENTION

One embodiment of the present invention provides for a method for recovering any residual specialty oil from a cake using a compressed solvent by first heating the compressed solvent. The specialty oil is extracted from the cake using the compressed solvent. The compressed solvent is then expanded and heated to vapor phase. Finally, the specialty oil is separated from the compressed solvent. This recovery process is the same for any specialty oil.

Another embodiment of the present invention provides for a method for recovering residual specialty oil from a cake using a compressed solvent. First, the compressed solvent is heated. Next the specialty oil is extracted from a cake using the compressed solvent. The compressed solvent is expanded and heated to vapor phase. Finally, the specialty oil is separated from the compressed solvent. This embodiment of the present invention contemplates that the specialty oil is selected from the group consisting of borage, evening primrose, flaxseed, hemp, black currant, walnut, jojoba, rosehip, sesame, almond, avocado, black cumin, grapeseed, kukui nut, macadamia nut, olive, pecan nut, perilla, poppyseed, pumpkin, sea buckthom, shea nut, tamanu and watermelon.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 shows one embodiment of the present invention in which the extraction involves the use of a storage tank, a precooler, a pump, a preheater, an extractor, a pressure regulator, a high pressure vaporizer, a cyclone separator, and a condenser; and

FIG. 2 illustrates another embodiment of the present invention in which high pressure recycling is performed.

### DETAILED DESCRIPTION OF THE INVENTION

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated method, and such further applications of the principles of the invention illustrated herein, as would normally occur to persons skilled in the art to which the invention relates.

One embodiment of the present invention provides a means for recovering any residual specialty oil using a compressed solvent. In the present invention, a compressed solvent is used to extract the remaining specialty oil from a cake. Once the mechanical treatment has been performed and the initial oil has been removed, the cake is processed by extraction. This involves the steps of heating the compressed solvent, extracting the specialty oil from the cake using the compressed solvent, expanding and heating the compressed solvent to vapor phase, and separating the specialty oil from the compressed solvent. This recovery process is the same for any specialty oil.

In one embodiment of the present invention, the specialty oil contained in the cake is selected from the group consisting of borage, evening primrose, flaxseed, hemp, black currant, walnut, jojoba, rosehip seed, sesame seed, almond, avocado, black cumin, grapeseed, kukui nut, macadamia nut, olive, pecan nut, perilla, poppyseed, pumpkin, sea buckthom, shea nut, tamanu and watermelon.

Any specialty oil can be extracted using an expeller. Similarly, it will be obvious to one skilled in the art that this invention may be applied to, and includes, any other specialty oil. Specialty oils are lipophilic in nature. Although there are slight differences in the fatty acid profiles of each specialty oil, all of them are soluble in compressed solvents, especially in carbon dioxide. Because of their low viscosity, high diffusion coefficients and negligible surface tension compressed solvents are able to percolate through the solid matrix of any after-pressed cake of specialty oils and extract the residual oil.

In one embodiment of the present invention the compressed solvent used in the process is selected from the group consisting of ethane, propane, carbon dioxide, ethanol, nitrous oxide, butane, isobutene, sulfur hexafluoride, trifluoromethane, dimethylether, or a combination thereof. It will be obvious to one skilled in the art that this invention may include other solvents. However, the preferred compressed solvent is carbon dioxide.

In some embodiments of the present invention, the specialty oil in the cake could be directly extracted using a supercritical fluid or the cake could be roasted before extraction. Roasting is one form of pretreatment. In other embodiments of the invention other forms of pretreatment such as grinding may be used. Additionally, the process can be carried out under a range of operating conditions. In various embodiments of the present invention, temperatures can range between 10° C. and 120° C. and pressures can be in the range of 20 bar to 1000 bar, preferably above 550 bar. The amount of specialty oil extracted from the cake is preferably greater than or equal to 90%. Extraction using a compressed solvent allows for oil recovery greater than 90% in a single step. Extraction with a traditional organic solvent, such as hexane, requires the additional steps of solvent evaporation as well as the necessity of toasting the cake. Other advantages to using the compressed solvent at higher pressures are shorter extraction times and lower solvent to feed ratios. The compressed solvent can be recycled, preferably, under supercritical or subcritical conditions. Additionally, in some embodiments of the present invention, the entire process is continuous.

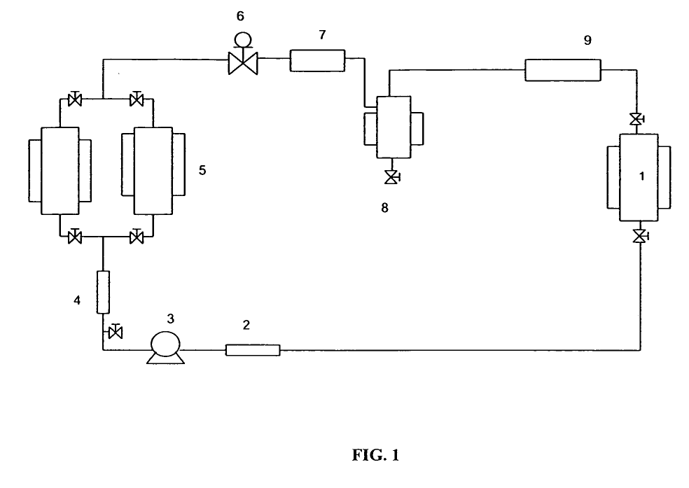

FIG. 1 is one example of one embodiment of the present invention. A compressed solvent is pumped from a storage tank 1 to a low pressure precooler 2 before entering a pump 3. The pump 3 pumps the compressed solvent to the desired extraction pressure. The compressed solvent then enters a high pressure preheater 4 to attain the desired extraction temperature. The cake containing the residual specialty oil is located in the extractor 5. The compressed solvent enters the extractor 5 and extracts the specialty oil from the cake. The compressed solvent and the extracted oil next move through an automated back pressure regulator 6 and a high pressure vaporizer 7. The specialty oil is then separated from the compressed solvent in a separator 8. Finally, the compressed solvent then passes through a low pressure condenser 9 before being recycled back to the storage tank 1. This recovery process is the same for any specialty oil.

In some embodiments of the invention, additional separators may be added to the system in case additional separations, or fractionation, are required. Multiple extraction vessels can also be implemented.

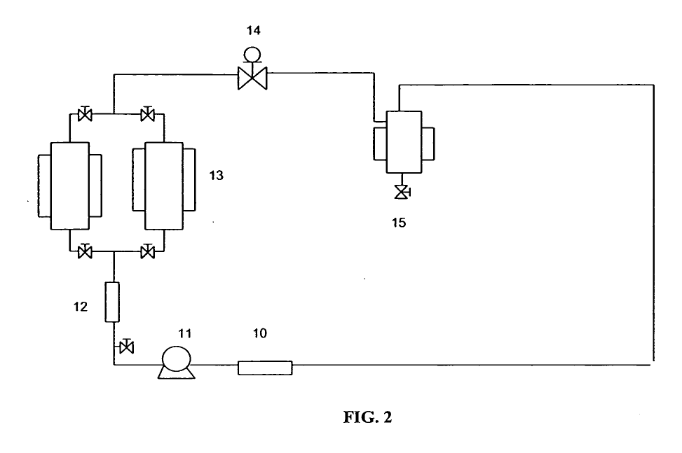

FIG. 2 is an example of another embodiment of the present invention in which high pressure recycling is performed. A compressed solvent is pumped to a low pressure precooler 10 before entering a pump 11. The pump 11 pumps the compressed solvent to the desired extraction pressure. The compressed solvent then enters a high pressure preheater 12 to attain the desired extraction temperature. The cake containing the residual specialty oil is located in the extractor 13. The compressed solvent enters the extractor 13 and extracts the specialty oil from the cake. The compressed solvent and the extracted specialty oil next move through an automated back pressure regulator 14. The specialty oil is then separated from the compressed solvent in a separator 15. In other embodiments of the invention, additional cyclone separators may be added to the system in case additional separations, or fractionation, are required. Multiple extraction vessels can also be implemented. Again, this recovery process is the same for any type of specialty oil.

In one embodiment of the present invention, the compressed solvent is carbon dioxide with an extraction temperature range of 10° C. to 120° C. and extraction pressure range of 20 to 1000 bar, preferably above 550 bar. The amount of residual specialty oil extracted from the cake is at least 90% and the compressed solvent can be recycled under supercritical or subcritical conditions. The type of recycling used depends on the specific extraction parameters, and recycling will make the present invention more energy efficient.

The following examples clearly illustrate some embodiments of the present invention:

### EXAMPLE 1

500 grams of roasted sesame powder (after pressing) were placed into a 1 liter extraction vessel system manufactured by Thar Technologies, Inc. The oil content in the cake was 20%. The experimental conditions used can be found in the following table.

Experimental conditions:

| | | |
|---|---|---|
| Temperature | (° C.) | 40 |
| Pressure | (bar) | 400 |
| CO₂ flow rate | (g/min) | 50 |
| Cyclone pressure | (bar) | 40 |
| Cyclone temperature | (° C.) | 25 |

Recovery of specialty oil based on hexane extraction: 95%

### EXAMPLE 2

6 kilograms of roasted sesame powder (after pressing) were placed into a 12 liter extraction vessel system manufactured by Thar Technologies, Inc. The specialty oil content in the cake was 9.5%. The experimental conditions used can be found in the following table.

Experimental conditions:

| | | |
|---|---|---|
| Temperature | (° C.) | 40 |
| Pressure | (bar) | 550 |
| CO₂ flow rate | (kg/min) | 1 |
| Cyclone pressure | (bar) | 67 |
| Cyclone temperature | (° C.) | 27 |

Recovery of specialty oil based on hexane extraction: 96.5%

### EXAMPLE III

4 kilograms of roasted sesame powder (after pressing) were placed into a 12 liter extraction vessel system manufactured by Thar Technologies, Inc. The oil content in the cake was 21%. The experimental conditions used can be found in the following table.

Experimental conditions:

| | | |
|---|---|---|
| Temperature | (° C.) | 60 |
| Pressure | (bar) | 800 |
| CO₂ flow rate | (g/min) | 1000 |
| Cyclone pressure | (bar) | 55 |
| Cyclone temperature | (° C.) | 28 |

Recovery of specialty oil based on hexane extraction: 97%

### EXAMPLE IV

500 grams of flaxseed powder (after pressing) were placed into a 1 liter extraction vessel system manufactured by Thar Technologies, Inc. The specialty oil content in the cake was 12%. The experimental conditions used can be found in the following table.

Experimental conditions:

| | | |
|---|---|---|
| Temperature | (° C.) | 60 |
| Pressure | (bar) | 600 |
| CO₂ flow rate | (g/min) | 100 |
| Cyclone pressure | (bar) | 55 |
| Cyclone temperature | (° C.) | 40 |

Recovery of specialty oil based on hexane extraction: 95.2%.

We claim:

1. A method for recovering any residual specialty oil from a cake using a compressed solvent comprising the steps of:
a. heating the compressed solvent;
b. extracting the specialty oil from a cake using the compressed solvent;
c. expanding and heating the compressed solvent to vapor phase; and
d. separating the specialty oil from the compressed solvent.

2. The method according to claim 1 wherein the cake contains a solid selected from the group consisting of borage, evening primrose, flaxseed, hemp, black currant, walnut, jojoba, rosehip seed, sesame seed, almond, avocado, black cumin, grapeseed, kukui nut, macadamia nut, olive, pecan nut, perilla, poppyseed, pumpkin, sea buckthom, shea nut, tamanu and watermelon.

3. The method according to claim 1 wherein the compressed solvent is selected from the group consisting of ethane, propane, carbon dioxide, ethanol, nitrous oxide, butane, isobutene, sulfur hexafluoride, trifluoromethane, dimethylether, and a combination thereof.

4. The method according to claim 1 wherein the desired extraction temperature is in the range of 10° C. to 120° C.

5. The method according to claim 1 wherein the desired extraction pressure is in the range of 20 bar to 1000 bar.

6. The method according to claim 1 wherein the amount of residual specialty oil extracted from the cake is at least 90%.

7. The method according to claim 1 wherein the compressed solvent is recycled.

8. The method according to claim 7 wherein the compressed solvent is recycled under supercritical conditions.

9. The method according to claim 7 wherein the compressed solvent is recycled under subcritical conditions.

10. The method according to claim 1 wherein the cake is pretreated before extraction.

11. The method according to claim 1 wherein the process is continuous.

12. A method for recovering any residual specialty oil from a cake using a compressed solvent comprising the steps of:
a. heating the compressed solvent;
b. extracting the specialty oil from a cake using the compressed solvent;
c. expanding and heating the compressed solvent to vapor phase;
d. separating the specialty oil from the compressed solvent; and
e. wherein the specialty oil is selected from the group consisting of borage, evening primrose, flaxseed, hemp, black currant, walnut, jojoba, rosehip seed, sesame seed, almond, avocado, black cumin, grapeseed, kukui nut, macadamia nut, olive, pecan nut, perilla, poppyseed, pumpkin, sea buckthorn, shea nut, tamanu and watermelon.

13. The method according to claim 12 wherein the compressed solvent is selected from a group consisting of ethane, propane, carbon dioxide, ethanol, nitrous oxide, butane, isobutene, sulfur hexafluoride, trifluoromethane, dimethylether, and a combination thereof.

14. The method according to claim 12 wherein the desired extraction temperature is in the range of 10° C. to 120° C.

15. The method according to claim 12 wherein the desired extraction pressure is in the range of 20 bar to 1000 bar.

16. The method according to claim 12 wherein the amount of residual specialty oil extracted from the cake is at least 90%.

17. The method according to claims 12 wherein the compressed solvent is recycled.

18. The method according to claim 17 wherein the compressed solvent is recycled under supercritical conditions.

19. The method according to claim 17 wherein the compressed solvent is recycled under subcritical conditions.

20. The method according to claim 12 wherein the cake is pretreated.

21. The method according to claim 12 wherein the process is continuous.
